(19) United States
(12) Patent Application Publication
(10) Pub. No.: US 2019/0325363 A1
(43) Pub. Date: Oct. 24, 2019

(54) BUSINESS INSIGHT GENERATION SYSTEM

(71) Applicant: ADP, LLC, Roseland, NJ (US)

(72) Inventors: Manoj Oleti, Hyderabad (IN); Pradyumna Mohapatra, Hyderabad (IN); Amit Kumar Sharma, Hyderabad (IN); Srinivasa Rao Kummarapu, Hyderabad (IN); Marc Rind, Summit, NJ (US); Richard Wilson, Randolf, NJ (US); Uday Kovur, Hyderabad (IN)

(21) Appl. No.: 15/961,285

(22) Filed: Apr. 24, 2018

(51) Int. Cl. G06Q 10/06; G06Q 10/10

(52) U.S. Cl. CPC G06Q 10/0637; G06Q 10/105

(57) ABSTRACT

A method, an apparatus, and a computer program product for digitally presenting a statistically relevant business insights into a set of business metrics for an organization. A computer system generates a plurality of dimension aggregates for facts of human resources data across a plurality of different combinations of dimensions of human resources data. The computer system identifies a set of comparable aggregates among the plurality of dimension aggregates based on an intersection of the dimensions of human resources data among the different combinations. The computer system generates a set of statistics for each comparable aggregate of the set of comparable aggregates. The computer system generates a business insight into the set of business metrics of the organization based on the set of statistics for the set of comparable aggregates. The computer system digitally presents the business insight.

### BACKGROUND INFORMATION

### 1. Field

The present disclosure relates generally to an improved computer system and, in particular, to a method and apparatus for accessing information in a computer system. Still more particularly, the present disclosure relates to a method, a system, and a computer program product for digitally generating and presenting statistically relevant business insights into a set of business metrics for an organization.

### 2. Background

Information systems are used for many different purposes. For example, an information system may be used to process payroll to generate paychecks for employees in an organization. Additionally, an information system also may be used by a human resources department to maintain benefits and other records about employees. For example, a human resources department may manage health insurance plans, wellness plans, and other programs and organizations using an employee information system. As yet another example, an information system may be used to hire new employees, assign employees to projects, perform reviews for employees, and other suitable operations for the organization. As another example, a research department in the organization may use an information system to store and analyze information to research new products, analyze products, or for other suitable operations.

Currently used information systems include databases. These databases store information about the organization. For example, these databases store information about employees, products, research, product analysis, business plans, and other information about the organization.

Information about the employees may be searched and viewed to perform various operations within an organization. However, this type of information in currently used databases may be cumbersome and difficult to access relevant information in a timely manner that may be useful to performing an operation for the organization. For example, while regular aggregation methods to generate metrics can be used to get a bird's eye view of an organization, it may often be the case that a single metric in itself is not insightful. Rather, a significant change in the value of the metric as observed over a period of time or compared with sections of the company may provide a deeper understanding into the different conditions that drive those business metrics. For example, an insight into the turnover rate for an organization that identifies “turnover rate of sales department has increased 8% on the year as compared to last year” is more insightful than “turnover rate in a company 12% this year.”

Therefore, it would be desirable to have a method and apparatus that take into account at least some of the issues discussed above, as well as other possible issues. For example, it would be desirable to have a method and apparatus that overcome the technical problem of presenting a potentially competitive human resource migration model for an organization.

### SUMMARY

An embodiment of the present disclosure provides a method for digitally presenting statistically relevant business insights into a set of business metrics for an organization. A computer system generates a plurality of dimension aggregates four fax of human resources data across a plurality of different combinations of dimensions of the human resources data. The computer system identifies a set of comparable aggregates among the plurality of dimension aggregates. Comparable aggregates are identified based on an intersection of the dimensions of human resources data among the different combinations. The computer system generates a set of statistics for each comparable aggregate of the set of comparable aggregates. The computer system generates a business insight into the set of business metrics of the organization based on a combination of the set of statistics for a corresponding combination of dimensions of the human resources data. The computer system digitally presents the business insight.

Another embodiment of the present disclosure provides a computer system for digitally presenting statistically relevant business insights into a set of business metrics for an organization. The computer system comprises a hardware processor, a display system, and an insight engine in communication with the hardware processor and the display system. The insight engine generates a plurality of dimension aggregates four fax of human resources data across a plurality of different combinations of dimensions of the human resources data. The insight engine identifies a set of comparable aggregates among the plurality of dimension aggregates based on an intersection of the dimensions of human resources data among the different combinations. The insight engine generates a set of statistics for each comparable aggregate of the set of comparable aggregates. The insight engine generates a business insight into the set of business metrics of the organization based on a combination of the set of statistics for a comp corresponding combination of dimensions of human resources data. The insight engine digitally presents the business insight.

Yet another embodiment of the present disclosure provides a computer program product for digitally presenting statistically relevant business insights into a set of business metrics for an organization. The computer program product comprises a non-transitory computer readable storage media and program code, stored on the computer readable storage media. The program code includes code for generating a plurality of dimension aggregates four fax of human resources data across a plurality of different combinations of dimensions of human resources data. The program code includes code for identifying a set of comparable aggregates form the plurality of dimension aggregates based on an intersection of the dimensions of human resources data among the different combinations. The program code includes code for generating a set of statistics for each comparable aggregate of the set of comparable aggregates. The program code includes code for generating a business insight into the set of business metrics of the organization based on a combination of the set of statistics for a corresponding combination of dimensions of human resources data. The program code includes code for digitally presenting the business insight.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a block diagram of a human resources information environment in accordance with an illustrative embodiment;

FIG. 2 is a block diagram of a data flow for determining a business insight within a human resources modeling system in accordance with an illustrative embodiment;

FIG. 3 is a diagram of a business insight generated from comparable aggregates in accordance with an illustrative embodiment;

FIG. 4 is a diagram of different comparisons generated from comparable aggregates in accordance with an illustrative embodiment;

FIG. 5 is a flowchart of a process for digitally presenting statistically relevant business insights into a set of business metrics for an organization in accordance with an illustrative embodiment; and

FIG. 6 is a block diagram of a data processing system in accordance with an illustrative embodiment.

### DETAILED DESCRIPTION

The illustrative embodiments recognize and take into account one or more different considerations. For example, the illustrative embodiments recognize and take into account that an employer may need information about the effects of human resources information on business metrics when performing certain operations. The illustrative embodiments also recognize and take into account that searching information systems for business insights into human resources information, and identifying the effects of human resources information on business metrics, may be more cumbersome and time-consuming than desirable.

The illustrative embodiments also recognize and take into account that digitally presenting statistically relevant business insights into business metrics for an organization may facilitate accessing information about appropriate human resources data when performing operations for an organization. The illustrative embodiments also recognize and take into account that identifying business insights into human resources data and their effects on business metrics may still be more difficult than desired.

Thus, the illustrative embodiments provide a method, an apparatus, and a computer program product for digitally presenting statistically relevant business insights into a set of business metrics for an organization. A computer system generates a plurality of dimension aggregates for facts of human resources data across a plurality of different combinations of dimensions of human resources data. The computer system identifies a set of comparable aggregates among the plurality of dimension aggregates based on an intersection of the dimensions of human resources data among the different combinations. The computer system generates a set of statistics for each comparable aggregate of the set of comparable aggregates. The computer system generates a business insight into the set of business metrics of the organization based on the set of statistics for the set of comparable aggregates. The computer system digitally presents the business insight.

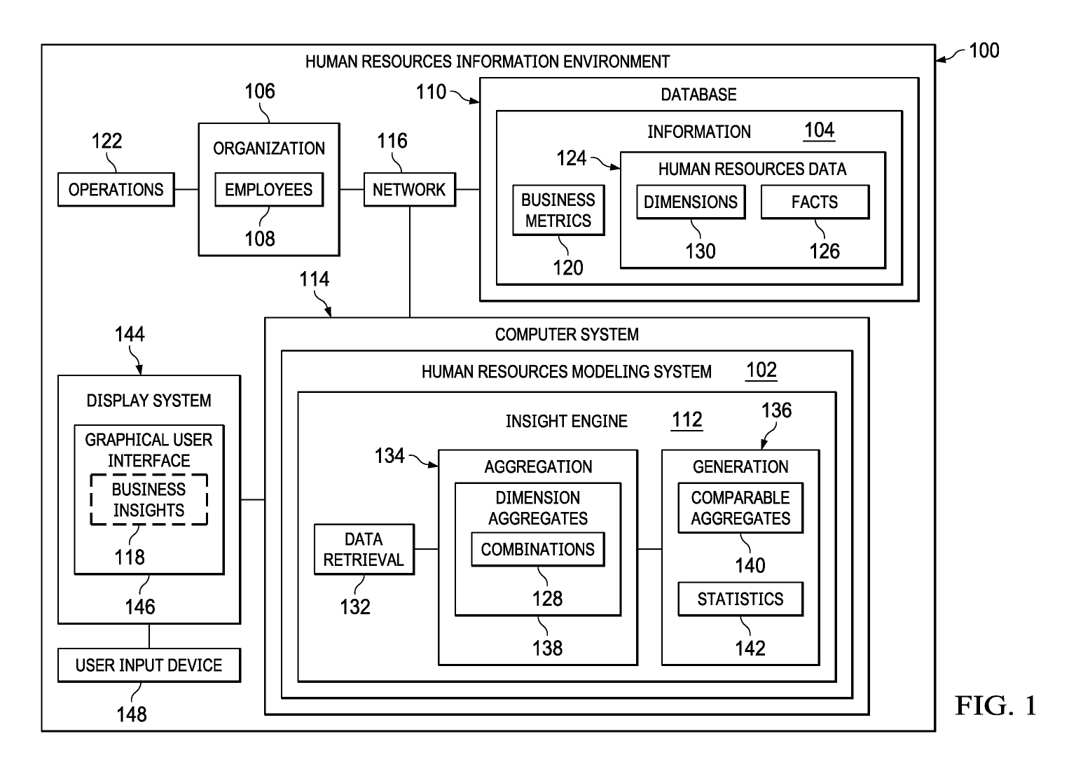

With reference now to the figures and, in particular, with reference to FIG. 1, an illustration of a block diagram of a human resources migration environment is depicted in accordance with an illustrative embodiment. As depicted, human resources information environment 100 includes human resources modeling system 102.

Human resources modeling system 102 may take different forms. For example, human resources modeling system 102 may be selected from one of an employee information system, a research information system, a sales information system, an accounting system, a payroll system, a human resources system, or some other type of information system that stores and provides access to information 104.

Information 104 can include information about organization 106 and employees 108 of organization 106. Information 104 may include, for example, at least one of information about people, products, research, product analysis, business plans, financials, or other information relating to organization 106 and employees 108. As depicted, information 104 is stored on database 110.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Organization 106 may be, for example, a corporation, a partnership, a charitable organization, a city, a government agency, or some other suitable type of organization. Employees 108 are people who are employed by or associated with organizations 106. For example, employees 108 can include at least one of employees, administrators, managers, supervisors, and third parties associated with organization 106.

In this illustrative example, human resources modeling system 102 includes insight engine 112. Insight engine 112 may be implemented in computer system 114.

Computer system 114 is a physical hardware system and includes one or more data processing systems. When more than one data processing system is present, those data processing systems may be in communication with each other using a communications medium. The communications medium may be a network, such as network 116. The data processing systems may be selected from at least one of a computer, a server computer, a workstation, a tablet computer, a laptop computer, a mobile phone, or some other suitable data processing system.

In this illustrative example, insight engine 112 generates business insights 118. As used herein, a “business insight” is an actionable, data-driven finding that creates business value impacting one or more business metrics 120. A business insight provides the “aha moment” for organization 106, which can trigger a smart business decision, or an idea for a new feature or business process or marketing strategy. In order for the value to be realized, business insights 118 provide useful and actionable information that is easy to comprehend. Business insights 118 can be time bound and readily available, enabling organization 106 to uncover potential issues that may otherwise be missed within information 104.

By generating business insights 118, insight engine 112 enables the performance of operations 122 by organization 106 that may promote desired changes to business metrics 120 of organization 106. For example, insight engine 112 allows organization 106 to perform operations 122 based on changes to business metrics 120 of organization 106.

Insight engine 112 may be implemented in software, hardware, firmware, or a combination thereof. When software is used, the operations performed by insight engine 112 may be implemented in program code configured to run on hardware, such as a processor unit. When firmware is used, the operations performed by insight engine 112 may be implemented in program code and data and stored in persistent memory to run on a processor unit. When hardware is employed, the hardware may include circuits that operate to perform the operations in insight engine 112.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

Insight engine 112 determines business insights 118 for human resources data 124. Human resources data 124 is information 104 about employees 108 of organization 106. Insight engine 112 can identify business insights 118 from facts 126 about human resources data 124 by comparing different ones of combinations 128 of dimensions 130 qualifying a particular fact.

In one illustrative example, insight engine 112 identifies facts 126 by receiving a selection of different ones of facts 126. In this manner, insight engine 112 is “user configurable,” allowing a user to select relevant ones of facts 126, and generating business insights 118 by comparing different ones of combinations 128 of dimensions 130 for ones of facts 126 selected by the user.

Insight engine 112 can include a number of different components. As used herein, “a number of” means one or more components. As depicted, insight engine 112 includes data retrieval 132, aggregation 134, and generation 136.

Data retrieval 132 identifies facts 126 and dimensions 130 from human resources data 124, and provides the identified information to aggregation 134. Aggregation 134 generates a plurality of dimension aggregates 138 for facts 126 of human resources data 124. As used herein, “facts” are human resources data 124 that correspond to a particular one of business metrics 120; “dimensions” are groups of hierarchies and descriptors that define facts 126. Aggregation 134 generates a full or partial aggregation of facts 126 across a plurality of different ones of combinations 128 of dimensions 130 of human resources data 124.

With each and every addition of dimensions 130, aggregation of facts 126 becomes computationally very expensive. In one illustrative example, insight engine 112 leverages big-data infrastructure to scale out and address the exponential growth in computational resources required by the inclusion of additional data dimensions.

Generation 136 identifies a set of comparable aggregates 140 among the plurality of dimension aggregates 138. As used herein, “comparable aggregates” are different ones of dimension aggregates 138 that have intersecting ones of combinations 128 of dimensions 130 of human resources data 124. In this manner, generation 136 identifies a set of comparable aggregates 140 based on an intersection of dimensions 130 of human resources data 124 among the different ones of combinations 128.

Generation 136 generates a set of statistics 142 for each comparable aggregate of the set of comparable aggregates 140. In one illustrative example, generation 136 generates a set of distributions for facts 126 of human resources data 124 across the set of comparable aggregates 140. Generation 136 then generates the set of statistics 142 for each of comparable aggregates 140 in relation to the set of distributions. In one illustrative example, the set of statistics 142 comprises at least one of an absolute difference, a percentage difference, a Z-score, a p-value, and a percentile rank, as well as other appropriate statistics and combinations thereof.

Generation 136 generates business insights 118 into the set of business metrics 120 of organization 106. Generation 136 generates business insights 118 based on the set of statistics 142 for the set of comparable aggregates 140.

Insight engine 112 then digitally presents business insights 118 for organization 106. In this illustrative example, computer system 114 can display business insights 118 on display system 144. In this illustrative example, display system 144 can be a group of display devices. A display device in display system 144 may be selected from one of a liquid crystal display (LCD), a light emitting diode (LED) display, an organic light emitting diode (OLED) display, and other suitable types of display devices.

By determining business insights 118, insight engine 112 enables more efficient performance of operations 122 for organization 106. For example, organization 106 can perform operations 122, such as, but not limited to, at least one of hiring, benefits administration, payroll, performance reviews, forming teams for new products, assigning research projects, or other suitable operations consistent with business insights 118.

In this illustrative example, business insights 118 are displayed in graphical user interface 146 on display system 144. An operator may perform operations 122 by interacting with graphical user interface 146 through user input generated by one or more of user input device 148, such as, for example, a mouse, a keyboard, a trackball, a touchscreen, a stylus, or some other suitable type of user input device.

Operations 122 that are performed consistent with business insights 118 allows organization 106 to implement a human capital resources management strategy to positively effect changes in business metrics 120 based on identified correlations in human resources data 124. For example, business insights 118 allow organization 106 to perform operations based on identified correlations in human resources data 124 that positively affect business metrics 120.

In this illustrative example, human resources modeling system 102 digitally presents statistically relevant ones of business insights 118 into a set of business metrics 120 for organization 106. Insight engine 112 generates a plurality of dimension aggregates 138 for facts 126 of human resources data 124 across a plurality of different combinations of dimensions 130 of human resources data 124. Insight engine 112 identifies a set of comparable aggregates 140 among the plurality of dimension aggregates 138 based on an intersection of dimensions 130 of human resources data 124 among the different combinations. Insight engine 112 generates a set of statistics 142 for each comparable aggregate of the set of comparable aggregates 140. Insight engine 112 generates a business insight into the set of business metrics 120 of organization 106 based on the set of statistics 142 for the set of comparable aggregates 140. Insight engine 112 digitally presents the business insight.

The illustrative example in FIG. 1 and the examples in the other subsequent figures provide one or more technical solutions to overcome a technical problem of determining a statistically relevant insights into human resources data for an organization that make the performance of operations for an organization more cumbersome and time-consuming than desired. For example, when organization 106 performs operations 122 consistent with business insights 118, organization 106 implements a human capital resources management strategy in a manner that positively affects business metrics 120 based on identified correlations in human resources data 124.

In this manner, the use of human resources modeling system 102 has a technical effect of determining business insights 118 based on comparable aggregates 140, thereby reducing time, effort, or both in the performance of operations 122 for organization 106. In this manner, operations 122 performed for organization 106 may be performed more efficiently as compared to currently used systems that do not include human resources modeling system 102. For example, operations, such as, but not limited to, at least one of hiring, benefits administration, payroll, performance reviews, forming teams for new products, assigning research projects, or other suitable operations for organization 106, performed consistently with business insights 118 allows organization 106 to implement a human capital resources management strategy in a manner that positively affects business metrics 120 based on identified correlations in human resources data 124.

As a result, computer system 114 operates as a special purpose computer system in which human resources modeling system 102 in computer system 114 enables insight engine 112. In this illustrative example, human resources modeling system 102 digitally presents statistically relevant ones of business insights 118 into a set of business metrics 120 for organization 106. Insight engine 112 generates a plurality of dimension aggregates 138 for facts 126 of human resources data 124 across a plurality of different ones of combinations 128 of dimensions 130 of human resources data 124. Insight engine 112 identifies a set of comparable aggregates 140 among the plurality of dimension aggregates 138 based on an intersection of dimensions 130 of human resources data 124 among the different combinations. Insight engine 112 generates a set of statistics 142 for each comparable aggregate of the set of comparable aggregates 140. Insight engine 112 generates a business insight into the set of business metrics 120 of organization 106 based on the set of statistics 142 for the set of comparable aggregates 140. Insight engine 112 digitally presents the business insight.

Thus, human resources modeling system 102 transforms computer system 114 into a special purpose computer system as compared to currently available general computer systems that do not have human resources modeling system 102. Currently used general computer systems do not reduce the time or effort needed to determine statistically relevant ones of business insights 118 based on different ones of combinations 128 of human resources data 124.

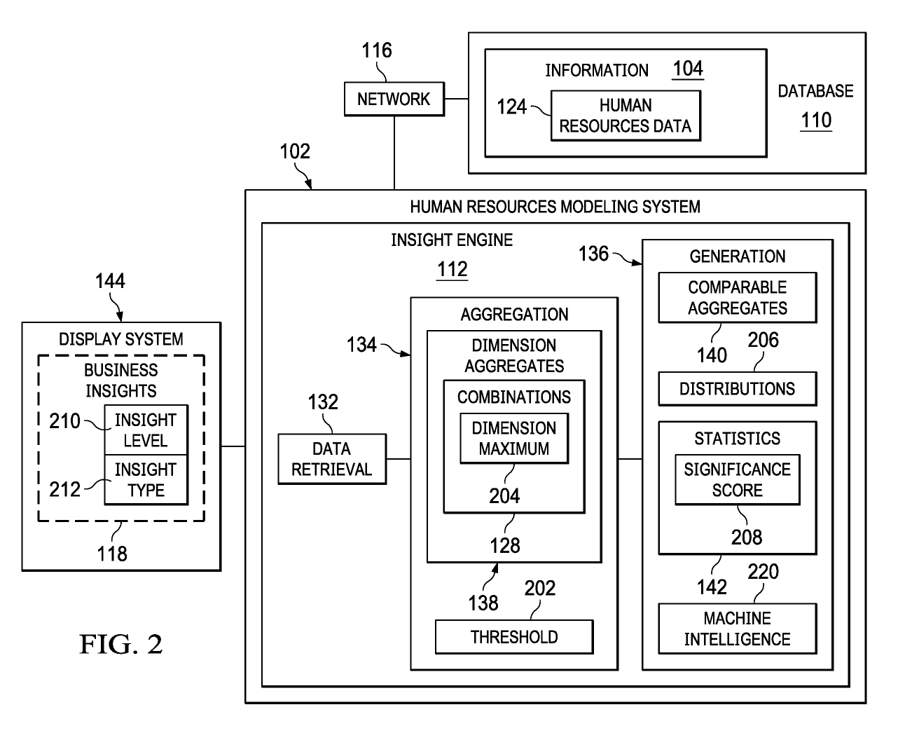

With reference next to FIG. 2, an illustration of a block diagram of a data flow for determining a business insight within a human resources modeling system is depicted in accordance with an illustrative embodiment. As depicted, human resources modeling system 102 is human resources modeling system 102 of FIG. 1.

As depicted, aggregation 134 further includes one or more threshold of 202. Threshold 202 defines a requisite number of corresponding data records in human resources data 124. In one illustrative example, as depicted, generating a plurality of dimension aggregates 138 limited by threshold 202 allows aggregation 134 to filter the plurality of dimension aggregates 138. By filtering the plurality of dimension aggregates 138, insight engine 112 excludes combinations 128 of dimension aggregates 138 that do not exceed threshold 202 defining a requisite number of corresponding data records.

As depicted, combinations 128 comprises dimension maximum 204. Dimension maximum 204 is a maximum number of dimensions of human resources data 124 over which dimension aggregates 138 are determined. By limiting the number of dimensions, dimension maximum 204 increases the comprehensibility of business insights 118. In one illustrative example, dimension maximum 204 can be as many as 15 different dimensions of human resources data 124. Preferably, dimension maximum 204 is at most four dimensions of human resources data 124.

In one illustrative example, each set of comparable aggregates 140 consists of different intersecting ones of dimension aggregates 138. In this illustrative example, only one dimension of human resources data 124 varies among the set of comparable aggregates 140. By limiting the number of variable dimensions in a set of comparable aggregates 140, insight engine 112 can increase the comprehensibility and usability of business insights 118. Business insights 118 generated in this manner highlight the effect of a particular data dimension on a particular fact of human resources data 124.

In one illustrative example, each set of comparable aggregates 140 consists of different intersecting ones of dimension aggregates 138. In this illustrative example, none of the dimensions of human resources data 124 vary among the set of comparable aggregates 140. Continuing with the current example, generation 136 generates business insights 118 based on a correlation among different ones of the facts of human resources data 124 across an identical combination of dimensions of human resources data 124. By aggregating different facts over an identical combination of data dimensions, insight engine 112 can increase the comprehensibility and usability of business insights 118. Business insights 118 generated in this manner highlight correlations between different facts of human resources data 124, aggregated over an identical combination of dimensions.

In one illustrative example, generation 136 generates a set of distributions 206 for a set of facts across the set of comparable aggregates 140. Statistics 142 are then generated for each one of comparable aggregates 140 in relation to the set of distributions 206. In this illustrative example, the set of statistics 142 comprises at least one of an absolute difference, a percentage difference, a Z-score, a p-value, and a percentile rank, as well as other appropriate statistics and combinations thereof.

As depicted, statistics 142 include significance score 208. Significance score 208 is a measure of a statistical relevance for business insights 118. Significance score 208 provides a measure of how statistically “interesting” that a particular business insight may be to an organization. Significance score 208 may be determined by leveraging one or more of statistics 142, including a percentage difference, a Z-score, and a p-value, as well as other factors including a number of employees covered by the insight, a time-recency of the insight, and a number of dimensions in the insight.

In this illustrative example, significance score 208 may be compared to a relevance threshold. Insight engine 112 digitally presents the corresponding one of business insight 118 only when significance score 208 for the corresponding one of business insight 118 exceeds the relevance threshold. When business insights 118 are determined in this manner, insight engine 112 ensures that only statistically “interesting” business insights are presented, thereby enabling statistically relevant business insights to be uncovered more quickly and efficiently.

In this illustrative example, generation 136 includes machine intelligence 220, which may be connected to data retrieval 132 and aggregation 134. In this illustrative example, machine intelligence 220 can be implemented using one or more systems such as an artificial intelligence system, a neural network, a Bayesian network, an expert system, a fuzzy logic system, a genetic algorithm, or other suitable types of systems.

Machine intelligence 220 may be configured to receive human resources data 124, to determine significance score 208, and to rank business insights 118. In an embodiment, machine intelligence 220 ranks business insights 118 according to significance score 208 to provide a ranking of how statistically “interesting” a particular business insight may be to an organization.

As depicted, business insights 118 includes insight level 210 and insight type 212. Insight level 210 are categorical filters that can be applied to human resources data 124 when determining business insights 118. For example, insight level 210 may include at least one of a country, an industry, a location, a union, a company size, a peer group, a talent competitor, or other groups that may be used to identify a subset of human resources data 124. In this illustrative example, insight levels 210 can include an organizational level insight and an industry level insight. Organizational level insights restricts human resources data 124 to data about organization 106. Industry level insights allows business insights 118 to be generated based on human resources data 124 for other comparable organizations across an industry.

As depicted, insight type 212 defines a type of comparison that is applied among different ones of comparable aggregates 140 for business insight 118. In one illustrative example, insight type 212 is selected from a maximum/minimum type insight, a statistical outlier type insight, a time series type insight, and a percentile rank type insight, as well as other relevant types of insights and combinations thereof.

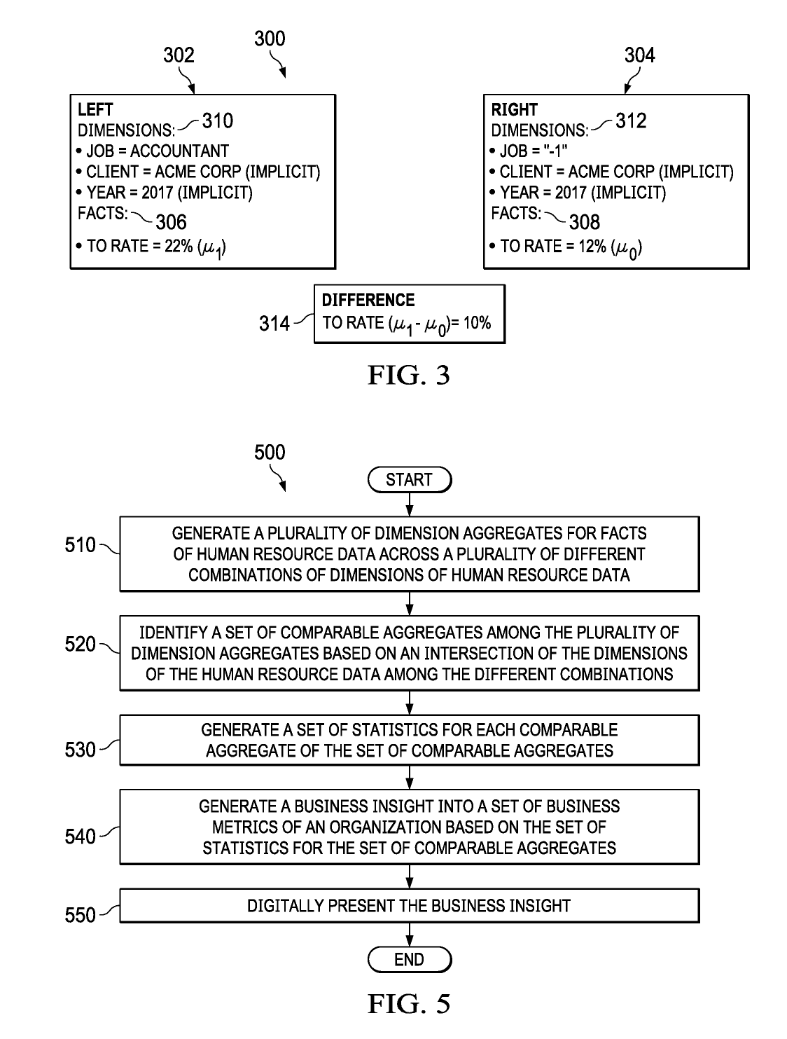

With reference next to FIG. 3, an illustration of a business insight generated from comparable aggregates is depicted in accordance with an illustrative embodiment. Business insight 300 is an example of business insight 119, shown in block form in FIG. 1.

As depicted, dimension aggregates 302 and 304 are comparable aggregates of facts 306 and 308, aggregated over dimensions 310 and 312, respectively. In this illustrative example, only a single dimension, “JOB,” is varied between dimension aggregates 302 and 304. Business insight 314 highlights the effect of the “JOB” data dimension on the “turnover rate” fact of human resources data.

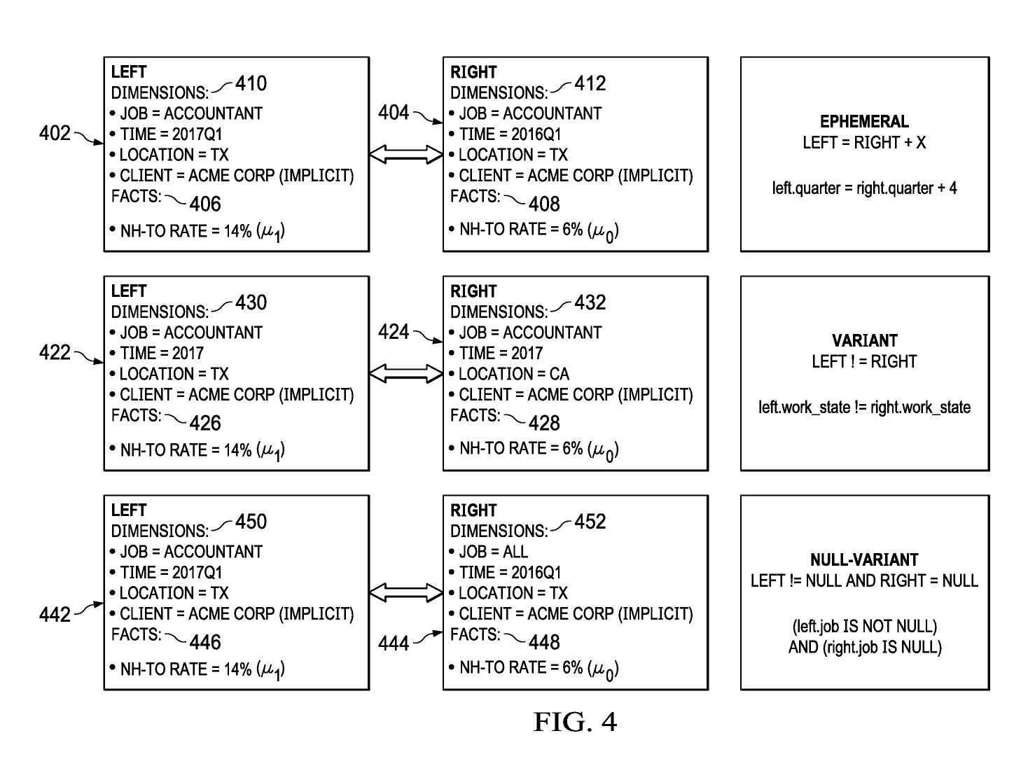

With reference next to FIG. 4, an illustration of different comparisons generated from comparable aggregates is depicted in accordance with an illustrative embodiment.

As depicted, dimension aggregates 402 and 404 are comparable aggregates of facts 406 and 408, aggregated over dimensions 410 and 412, respectively. In this illustrative example, only a single dimension, “TIME,” is varied between dimension aggregates 402 and 404. The comparison of dimension aggregates 402 and 404 is an “ephemeral” type comparison, wherein a particular dimension is varied by a determined amount among the comparable aggregates.

As depicted, dimension aggregates 422 and 424 are comparable aggregates of facts 426 and 428, aggregated over dimensions 430 and 432, respectively. In this illustrative example, only a single dimension, “LOCATION,” is varied between dimension aggregates 422 and 424. The comparison of dimension aggregates 422 and 424 is a “variant” type comparison, wherein a dimension aggregate aggregated over a first value of a particular dimension is compared to a dimension aggregate aggregated over a second value for the same dimension.

As depicted, dimension aggregates 442 and 444 are comparable aggregates of facts 446 and 448, aggregated over dimensions 450 and 452, respectively. In this illustrative example, only a single dimension, “JOB,” is varied between dimension aggregates 442 and 444. The comparison of dimension aggregates 442 and 444 is a “null-variant” type comparison, wherein a dimension aggregate aggregated over a first value of a particular dimension is compared to a dimension aggregate aggregated over all values for the same dimension.

With reference next to FIG. 5, an illustration of a flowchart of a process for digitally presenting statistically relevant business insights into a set of business metrics for an organization is depicted in accordance with an illustrative embodiment. The process of FIG. 5 can be a software process implemented in one or more components of a human resources modeling system, such as in insight engine 112 of FIG. 1.

Process 500 begins by generating a plurality of dimension aggregates for facts of human resources data across a plurality of different combinations of dimensions of human resources data (step 510). The dimension aggregates can be dimension aggregates 138, shown in block form in FIG. 1.

Process 500 identifies a set of comparable aggregates among the plurality of dimension aggregates based on an intersection of the dimensions of the human resources data among the different combinations (step 520). The comparable aggregates can be comparable aggregates 140, shown in block form in FIG. 1.

Process 500 generates a set of statistics for each comparable aggregate of the set of comparable aggregates (step 530). The set of statistics can be statistics 142, shown in block form in FIG. 1.

Process 500 generates a business insight into a set of business metrics of an organization based on the set of statistics for the set of comparable aggregates (step 540). The business insight can be business insight 118, shown in block form in FIG. 1.

Process 500 digitally presents the business insight (step 550), with the process terminating thereafter. The business insight can be presented on a display system, such as display system 144 shown in block form in FIG. 1.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

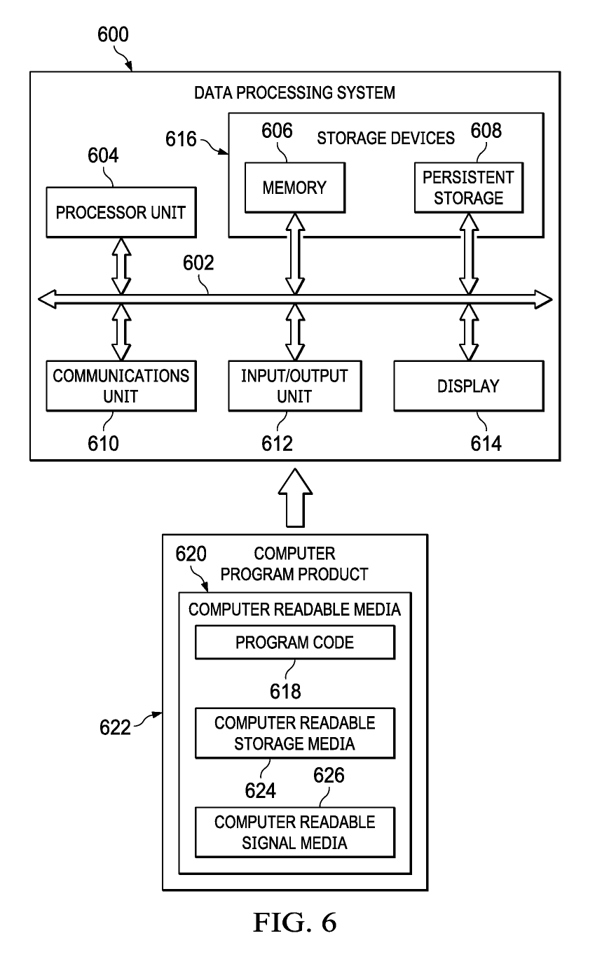

Turning now to FIG. 6, an illustration of a block diagram of a data processing system is depicted in accordance with an illustrative embodiment. Data processing system 600 may be used to implement human resources modeling system 102, computer system 114, and other data processing systems that may be used in human resources information environment 100 in FIG. 2. In this illustrative example, data processing system 600 includes communications framework 602, which provides communications between processor unit 604, memory 606, persistent storage 608, communications unit 610, input/output (I/O) unit 628, and display 614. In this example, communications framework 602 may take the form of a bus system.

Processor unit 604 serves to execute instructions for software that may be loaded into memory 606. Processor unit 604 may be a number of processors, a multi-processor core, or some other type of processor, depending on the particular implementation.

Memory 606 and persistent storage 608 are examples of storage devices 616. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 616 may also be referred to as computer readable storage devices in these illustrative examples. Memory 606, in these examples, may be, for example, a random access memory or any other suitable volatile or non-volatile storage device. Persistent storage 608 may take various forms, depending on the particular implementation.

For example, persistent storage 608 may contain one or more components or devices. For example, persistent storage 608 may be a hard drive, a solid state hard drive, a flash memory, a rewritable optical disk, a rewritable magnetic tape, or some combination of the above. The media used by persistent storage 608 also may be removable. For example, a removable hard drive may be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that may be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs may be located in storage devices 616, which are in communication with processor unit 604 through communications framework 602. The processes of the different embodiments may be performed by processor unit 604 using computer-implemented instructions, which may be located in a memory, such as memory 606.

These instructions are referred to as program code, computer usable program code, or computer readable program code that may be read and executed by a processor in processor unit 604. The program code in the different embodiments may be embodied on different physical or computer readable storage media, such as memory 606 or persistent storage 608.

Program code 618 is located in a functional form on computer readable media 620 that is selectively removable and may be loaded onto or transferred to data processing system 600 for execution by processor unit 604. Program code 618 and computer readable media 620 form computer program product 622 in these illustrative examples. In one example, computer readable media 620 may be computer readable storage media 624 or computer readable signal media 626.

In these illustrative examples, computer readable storage media 624 is a physical or tangible storage device used to store program code 618 rather than a medium that propagates or transmits program code 618.

Alternatively, program code 618 may be transferred to data processing system 600 using computer readable signal media 626. Computer readable signal media 626 may be, for example, a propagated data signal containing program code 618. For example, computer readable signal media 626 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 600 are not meant to provide architectural limitations to the manner in which different embodiments may be implemented. The different illustrative embodiments may be implemented in a data processing system including components in addition to or in place of those illustrated for data processing system 600. Other components shown in FIG. 6 can be varied from the illustrative examples shown. The different embodiments may be implemented using any hardware device or system capable of running program code 618.

Thus, one or more of the illustrative examples provide a method and apparatus to overcome the complexities and time needed to determine statistically relevant business insights into human resources information for an organization. One or more illustrative examples provide a technical solution that involves determining business insights for an organization based on comparable aggregates of human resources data of organizations. Determining the business insights for an organization in this manner reduces the amount of time, effort, or both in the performance of operations for the organization.

The implementation of a human resources modeling system provides an ability to implement a competitive human resources capital management strategy for the organization more easily as compared to current systems. When business insights are determined in this manner, the business insights may be relied upon to perform operations for an organization.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for digitally presenting statistically relevant business insights into a set of business metrics for an organization, the method comprising:
generating, by a computer system, a plurality of dimension aggregates for facts of human resources data across a plurality of different combinations of dimensions of human resources data;
identifying, by the computer system, a set of comparable aggregates among the plurality of dimension aggregates based on an intersection of the dimensions of human resources data among the plurality of different combinations;
generating, by the computer system, a set of statistics for each comparable aggregate of the set of comparable aggregates;
generating, by the computer system, a business insight into the set of business metrics of the organization based on the set of statistics for the set of comparable aggregates; and
digitally presenting, by the computer system, the business insight.

2. The method of claim 1, wherein generating the plurality of dimension aggregates further comprises:
filtering, by the computer system the plurality of dimension aggregates to exclude combinations of dimensions that do not exceed a threshold defining a requisite number of corresponding data records.

3. The method of claim 1, wherein each dimension aggregate comprises a maximum of four dimensions of human resources data.

4. The method of claim 1, wherein the set of comparable aggregates consists of intersecting dimension aggregates, wherein only one dimension of human resources data varies among the set of comparable aggregates.

5. The method of claim 1, wherein the set of comparable aggregates consists of intersecting dimension aggregates, wherein none of the dimensions of human resources data vary among the set of comparable aggregates; and
wherein generating the a business insight further comprises generating the business insight based on a correlation among different ones of the facts of human resources data across an identical combination of dimensions of human resources data.

6. The method of claim 1, further comprising:
generating, by the computer system a set of distributions for a set of facts across the set of comparable aggregates; and
wherein the set of statistics is generated for each comparable aggregate in relation to the set of distributions.

7. The method of claim 6, wherein the set of statistics comprises at least one of an absolute difference, a percentage difference, a Z-score, a p-value, a percentile rank, and combinations thereof.

8. The method of claim 1, further comprising:
determining, by the computer system, whether the business insight exceeds a threshold defining a requisite statistical relevance; and
wherein the computer system digitally presents the business insight in response to determining that the business insight exceeds the threshold.

9. The method of claim 1, wherein the business insight is selected from an organizational level insight and an industry level insight; and
wherein the business insight is further selected from a maximum/minimum type insight, a statistical outlier type insight, a time series type insight, and a percentile rank type insight.

10. The method of claim 1, further comprising:
performing, by the computer system, an operation for the organization based on the business insight, wherein the operation is enabled based on the business insight.

11. The method of claim 10, wherein the operation is selected from hiring operations, benefits administration operations, payroll operations, performance review operations, forming teams for new products, and assigning research projects.

12. A computer system comprising:
a hardware processor;
a display system; and
an insight engine in communication with the hardware processor and the display system, wherein the insight engine:
generates a plurality of dimension aggregates for facts of human resources data across a plurality of different combinations of dimensions of human resources data;
identifies a set of comparable aggregates among the plurality of dimension aggregates based on an intersection of the dimensions of human resources data among the plurality of different combinations;
generates a set of statistics for each comparable aggregate of the set of comparable aggregates;
generates a business insight into a set of business metrics of an organization based on the set of statistics for the set of comparable aggregates; and
digitally presents the business insight.

13. The computer system of claim 12, wherein generating the plurality of dimension aggregates further comprises:
filtering the plurality of dimension aggregates to exclude combinations of dimensions that do not exceed a threshold defining a requisite number of corresponding data records.

14. The computer system of claim 12, wherein each dimension aggregate comprises a maximum of four dimensions of human resources data.

15. The computer system of claim 12, wherein the set of comparable aggregates consists of intersecting dimension aggregates, wherein only one dimension of human resources data varies among the set of comparable aggregates.

16. The computer system of claim 12, wherein the set of comparable aggregates consists of intersecting dimension aggregates, wherein none of the dimensions of human resources data vary among the set of comparable aggregates; and
wherein generating the a business insight further comprises generating the business insight based on a correlation among different ones of the facts of human resources data across an identical combination of dimensions of human resources data.

17. The computer system of claim 12, wherein the insight engine further:
generates a set of distributions for a set of facts across the set of comparable aggregates; and
wherein the set of statistics is generated for each comparable aggregate in relation to the set of distributions.

18. The computer system of claim 17, wherein the set of statistics comprises at least one of an absolute difference, a percentage difference, a Z-score, a p-value, a percentile rank, and combinations thereof.

19. The computer system of claim 12, wherein the insight engine further:
determines whether the business insight exceeds a threshold defining a requisite statistical relevance; and
wherein the computer system digitally presents the business insight in response to determining that the business insight exceeds the threshold.

20. The computer system of claim 12, wherein the business insight is selected from an organizational level insight and an industry level insight; and
wherein the business insight is further selected from a maximum/minimum type insight, a statistical outlier type insight, a time series type insight, and a percentile rank type insight.

21. The computer system of claim 12, further comprising:
performing, by the computer system, an operation for the organization based on the business insight, wherein the operation is enabled based on the business insight.

22. The computer system of claim 21, wherein the operation is selected from hiring operations, benefits administration operations, payroll operations, performance review operations, forming teams for new products, and assigning research projects.

23. A computer program product for digitally presenting statistically relevant business insights into a set of business metrics for an organization, the computer program product comprising:
a non-transitory computer readable storage medium;
program code, stored on the computer readable storage medium, for generating a plurality of dimension aggregates for facts of human resources data across a plurality of different combinations of dimensions of human resources data;
program code, stored on the computer readable storage medium, for identifying a set of comparable aggregates among the plurality of dimension aggregates based on an intersection of the dimensions of human resources data among the plurality of different combinations;
program code, stored on the computer readable storage medium, for generating a set of statistics for each comparable aggregate of the set of comparable aggregates;
program code, stored on the computer readable storage medium, for generating a business insight into the set of business metrics of the organization based on the set of statistics for the set of comparable aggregates; and
program code, stored on the computer readable storage medium, for digitally presenting the business insight.

24. The computer program product of claim 23, wherein the program code for generating the plurality of dimension aggregates further comprises:
program code, stored on the computer readable storage medium, for filtering the plurality of dimension aggregates to exclude combinations of dimensions that do not exceed a threshold defining a requisite number of corresponding data records.

25. The computer program product of claim 23, wherein each dimension aggregate comprises a maximum of four dimensions of human resources data.

26. The computer program product of claim 23, wherein the set of comparable aggregates consists of intersecting dimension aggregates, wherein only one dimension of human resources data varies among the set of comparable aggregates.

27. The computer program product of claim 23, wherein the set of comparable aggregates consists of intersecting dimension aggregates, wherein none of the dimensions of human resources data vary among the set of comparable aggregates; and
wherein the program code for generating the a business insight further comprises program code for generating the business insight based on a correlation among different ones of the facts of human resources data across an identical combination of dimensions of human resources data.

28. The computer program product of claim 23, further comprising:
program code, stored on the computer readable storage medium, for generating a set of distributions for a set of facts across the set of comparable aggregates; and
wherein the set of statistics is generated for each comparable aggregate in relation to the set of distributions.

29. The computer program product of claim 28, wherein the set of statistics comprises at least one of an absolute difference, a percentage difference, a Z-score, a p-value, a percentile rank, and combinations thereof.

30. The computer program product of claim 23, further comprising:
program code, stored on the computer readable storage medium, for determining whether the business insight exceeds a threshold defining a requisite statistical relevance; and
program code, stored on the computer readable storage medium, for digitally presenting the business insight in response to determining that the business insight exceeds the threshold.

31. The computer program product of claim 23, wherein the business insight is selected from an organizational level insight and an industry level insight; and
wherein the business insight is further selected from a maximum/minimum type insight, a statistical outlier type insight, a time series type insight, and a percentile rank type insight.

32. The computer program product of claim 23, further comprising:
program code, stored on the computer readable storage medium, for performing an operation for the organization based on the business insight, wherein the operation is enabled based on the business insight.

33. The computer program product of claim 32, wherein the operation is selected from hiring operations, benefits administration operations, payroll operations, performance review operations, forming teams for new products, and assigning research projects.
